(19) United States
(12) Patent Application Publication
(10) Pub. No.: US 2014/0150004 A1
(43) Pub. Date: May 29, 2014

(54) CONDUCTING ADVERTISING EFFECTIVENESS SURVEYS

(71) Applicant: MICROSOFT CORPORATION, Redmond, WA (US)

(72) Inventors: Praveen Vemparala, Redmond, WA (US); Saleel Sathe, Sammamish, WA (US); Richard Prologo, Sammamish, WA (US); Sean P. Alexander, Sammamish, WA (US); David S. Alles, Seattle, WA (US); Ginny Musante, Mercer Island, WA (US)

(73) Assignee: MICROSOFT CORPORATION, Redmond, WA (US)

(21) Appl. No.: 13/685,573

(22) Filed: Nov. 26, 2012

(51) Int. Cl. H04N 21/81

(52) U.S. Cl. CPC H04N 21/812
USPC 725/13

(57) ABSTRACT

Embodiments for generating advertising effectiveness surveys are presented. One example method, performed in a computing device comprising a data-holding subsystem and logic subsystem, comprises receiving a request, the request associated with an identified user, from a video presentation device for a video content item, and providing the video content item to the video presentation device. Information relating to an image analysis is received in order to identify one or more image elements in the video content item, and information regarding user playback actions during playback of the video content item is received and stored. A user survey based upon the information related to the image analysis and the user playback actions is automatically retrieved, the user survey is sent to a device associated with the identified user, and a response to the user survey is received.

### BACKGROUND

To assess the effectiveness of a television or other video advertising campaign, advertisers may utilize third-party vendors to survey users regarding viewed advertising content. However, this approach may be costly, and also may include a significant time lag between when the advertising campaign is active and when the survey results are reported to the advertiser. Furthermore, it may be difficult to determine if the user actually viewed the advertising content.

### SUMMARY

Embodiments for generating advertising effectiveness surveys are disclosed herein. For example, one disclosed embodiment provides, on a computing device, a method including receiving a request from a video presentation device for a video content item, wherein the request is associated with an identified user, and providing the video content item to the video presentation device. The method further includes receiving information relating to an image analysis that identifies one or more image elements in the video content item, and receiving and storing information regarding user playback actions during playback of the video content item. The method further includes automatically retrieving a user survey based upon the information relating to the image analysis and the user playback, sending the user survey to a device associated with the identified user, and receiving a response to the user survey.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example advertising viewing environment according to an embodiment of the present disclosure.

FIG. 2 shows a flow chart illustrating a method for conducting an advertising effectiveness survey according to an embodiment of the present disclosure.

FIG. 3 shows a flow chart illustrating a method for presenting an advertising effectiveness study according to an embodiment of the present disclosure.

FIG. 4 schematically shows a video delivery and survey system according to an embodiment of the present disclosure.

FIG. 5 schematically shows a non-limiting example of a computing device.

### DETAILED DESCRIPTION

As mentioned above, with current advertising effectiveness research, there may be an undesirable time lag between conducting an advertising campaign and being able to complete a study of a usefulness of the campaign. As such, embodiments are disclosed herein that relate to providing advertising viewers with advertising-related surveys (e.g. questionnaires or any other mechanism of gathering user feedback) with less time lag between the viewing of the advertisement and the presentation of the survey. As described in more detail below, the disclosed embodiments may allow advertising effectiveness research to be provided to the advertisers with less time lag than conventional advertising effectiveness studies, and even over the course of the advertising campaign, rather than only after the campaign has ended.

In some embodiments, to identify which products, advertisements, brands, etc., a user has viewed, image analysis may be performed on video content presented to the user, either before, during, or after presentation, to identify such elements in the video content. A survey may then be assembled and sent to the user based on the identified elements, such that the user may take the survey soon after watching the advertisement. Further, to encourage users to complete the survey, users may be granted an award upon completion of the survey. Additionally, the survey may be presented in the form of a game to further engage users with the survey. Results of such surveys may be compiled and presented to the advertiser in an ongoing manner, thereby allowing the advertiser to view effectiveness data with little time lag relative to current methods of advertising effectiveness research.

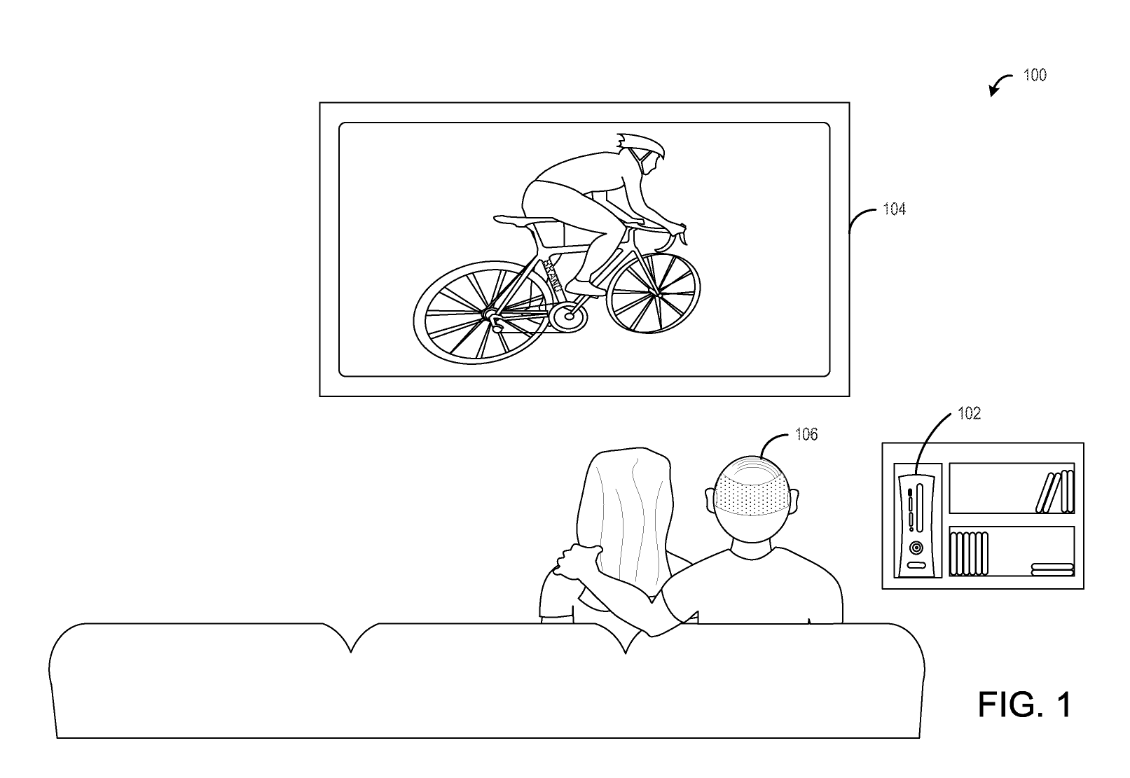

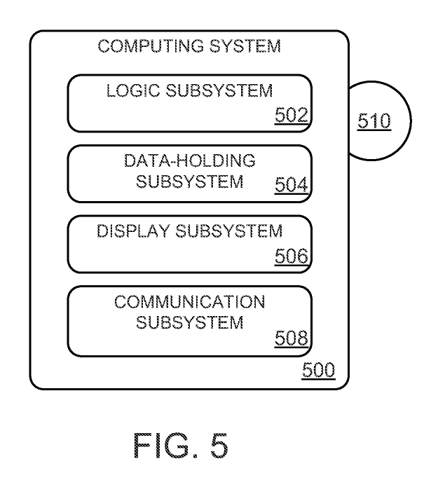

FIG. 1 shows a non-limiting example of a video content viewing environment 100 comprising a computing system 102 and a display device 104 in communication with the computing system 102. The computing system 102 may be configured to receive video content via a satellite feed, cable feed, over-the-air broadcast, computer network (e.g., the Internet), and/or any other suitable video delivery mechanism. Further, computing system 102 may include a playback device to present pre-recorded video content, such as DVDs. As such, computing system 102 also may be referred to as a video presentation device. Video content presented by the computing system 102 may include television programming, movies, video games, and/or any other suitable video content, presented in a live broadcast (e.g., in real time), on-demand, recorded for time-shifted playback after broadcasting, and/or in any other suitable manner. Computing system 102 may take the form of a laptop computer, television set-top box, digital video recorder, DVD player, television, or any other suitable form. More information regarding example embodiments of computing systems is presented below with reference to FIG. 5.

In addition to presenting video content, the computing system 102 also may be used to conduct advertising effectiveness research. For example, to help determine whether an advertising campaign is effective, an advertiser may wish to know whether a specific advertisement was watched, and if so, whether users remembered seeing an advertisement or product, the likelihood of a user purchasing an advertised product, etc.

Thus, as described above, the computing system 102 may be used to help conduct such research. For example, the computing system 102 may be used to monitor whether the user 106 viewed a particular advertisement (including pre-roll ads, mid-roll ads, post-roll ads, product placements within video content items, etc.), to provide such information to a remote service, to receive an advertising survey from the remote service, and present a survey to the user 106 regarding a particular product or advertisement that was presented to and likely viewed by the user.

As mentioned above, a video content delivery service (not shown in FIG. 1) that provides video content to the computing system 102 may be configured to identify elements within video content provided to and/or displayed by the computing system 102, such as products, brands, logos, etc. Further, during playback, the computing system 102 may be configured to monitor user-entered playback actions, such as pause, reverse, fast-forward, skip, and other such functions. This information may then be provided to the remote service, which may utilize this information to determine which segments of the video content were played by the user 106, and thus were likely to have been viewed by the user 106. The remote service then may automatically provide a user survey based on the identified elements and user playback actions. Such a user survey may poll the user 106 regarding the elements of interest within the video content, and the results of the user survey may then be presented to the advertiser.

Additionally, in some embodiments, upon completing the user survey, the user 106 may be granted an award as an incentive to respond to the survey. Any suitable award may be granted. Examples include virtual awards, such as an addition to a viewer score or an update to an avatar associated with the user 106, as well as physical awards, such as coupons for an advertised product or service, or an actual product.

In the specific example of FIG. 1, the user 106 is viewing a video of a bicycle of a specific brand, “BRAND.” Image analysis may be performed on the video (whether before, during, or after the viewer views the video) to locate product placements such as the particular bicycle shown. Then, after the video is presented to the user, a user survey may be retrieved (in complete form, assembled from individual retrieved questions, or in any other suitable manner), and presented to the user 106 to poll the user 106 regarding his or her opinion of BRAND bicycles. After completing the user survey, the user 106 may receive credits toward purchasing a bicycle.

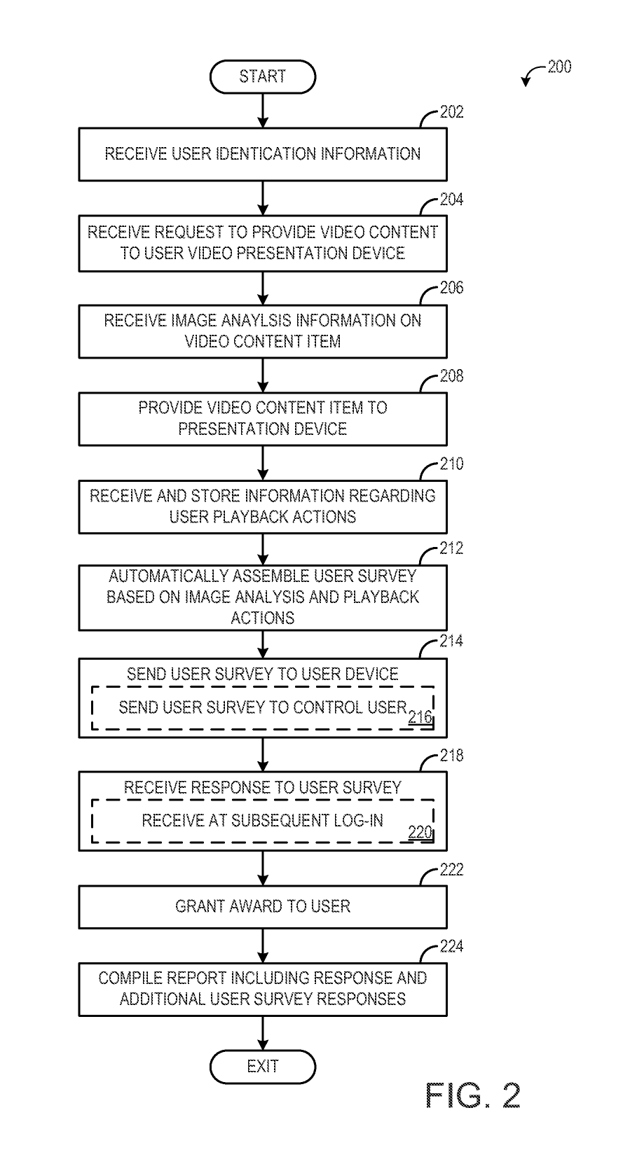

FIG. 2 shows a flow diagram depicting an embodiment of a method 200 for generating an advertising effectiveness survey for a user. Method 200 may be executed, for example, by a video delivery and survey service running on one or more devices configured to deliver video content to the computing system 102.

Method 200 comprises, at 202, receiving identification information regarding an identity of user that is or will be viewing video content. The identification information may be received during a login process for a viewing session, upon request by a previously logged-in user to view a video content item, and/or at any other suitable time. The user identification allows user viewing activities to be monitored and stored so that advertisements (including product placements) played by the user may be tracked. It will be understood that an anonymous identification (e.g. anonymous identification number or other anonymous user representation) may be utilized to track the user to maintain the user's privacy.

At 204, method 200 comprises receiving a request to provide a video content item to a video presentation device associated with the identified user. At 206, method 200 comprises receiving image analysis information on the video content item to identify one or more elements within the video content item. Any suitable identifiable element or object may be identified, including but not limited to images of people, products, brands, and/or logos. It will be understood that such image analysis may be performed prior to sending the video content item to the user video presentation device, in real-time during playback of the video content item, or after the user views the video content item. Further, the image analysis may be performed locally by the video delivery and survey service, or the image analysis may be performed by a third party and later provided to the video delivery and survey service. Any suitable type of image analysis may be utilized, including but not limited to video fingerprinting.

At 208, the video content item is provided to the user's video presentation device. The video content item may be played by the user immediately upon receiving the video content item, or the video content item may be stored for later playback. When the user plays the video content item, method 200 includes, at 210, receiving and storing information regarding user playback actions during consumption of the video content item. The user playback actions may include operation of various trick modes during playback of the video content item, such as pause, rewind, fast-forward, etc. By analyzing information regarding such trick mode operation, it may be determined whether each segment of the video content item was presented and therefore likely viewed, or whether some segments were skipped.

At 212, a user survey based on the image analysis and the user playback actions is retrieved (e.g. automatically) for the user. The user survey may include, for example, one or more questions regarding an element identified by the image analysis. Further, the user survey may include questions regarding an identified element that was presented to the user, as determined by the user playback actions. The user survey may be presented in any suitable manner. For example, the survey may be presented as a collection of questions displayed concurrently, as a series of questions displayed sequentially, or in any other suitable format. Further, in some embodiments, the user survey may be presented as a game-style quiz, which may increase user interest in taking the survey and/or enhance the user experience while taking the survey. Retrieval of the survey may comprise retrieving a previously prepared survey, retrieving individual questions for automatic assembly into a survey, and/or any other suitable actions.

At 214, the user survey is sent to a device associated with the user. In some instances, the device to which the survey is sent may be the video presentation device used to present the video content. In other instances, the survey may be sent to a different device associated with the user. For example, the user may view the video content item via a gaming system, but elect to receive such surveys via a mobile device, tablet computing device, or other device.

The user survey may be sent to the user's device at any suitable time. For example, the user survey may be sent to the user during the same viewing session in which the user viewed the video content item, or may be provided to the user upon logging in for a subsequent viewing session.

In addition to sending the survey to the user that watched the video content item, the user survey also may be sent to a control user at 216. The control user may be an identified user similar in demographics to the user that watched the video content item (e.g., similar age, gender, similar viewing habits, etc.), but that did not watch the video content item, or that did not view the identified element on which the user survey was assembled. Providing the survey to such a control user may help to ensure that statistical differences between the survey results of the user and the control user may be attributed to the impact of the viewed element. It will be understood that the survey may be sent to multiple users that viewed the content as well as multiple control viewers to assemble a survey data set of a desired size.

At 218, method 200 includes receiving a response to the user survey from the device of the user. The response may be received during the same viewing session that the user survey was sent, or during a subsequent viewing session following a later login, as indicated at 220. The responses may be received via any suitable inputs, including but not limited to via button or touch-based control devices, (e.g. remote controls, smart phones, notepad/laptop/other computing devices, etc.), voice input received by a microphone or other audio sensor, gesture input received by one or more cameras (e.g. 2d and/or depth cameras), and/or any other suitable types of inputs.

As mentioned above, an award may be provided for each survey the user takes to incentivize the user to complete the survey. Thus, method 200 comprises, at 222, granting an award to the user after the user responds to the user survey. As explained previously, the award may be virtual, such as an increase to a viewer score or update to an avatar, and/or may be physical, such as a coupon, currency-value credits that may be used toward the purchase of a product, etc. Further, in some embodiments, the control user may also receive an award for completing the user survey.

At 224, method 200 comprises compiling a report that includes the user response to the user survey, as well as additional responses to the user survey, such as the response completed by the control user and other users that were or were not exposed to the identified element. The report may be presented to the advertiser or other interested party. Such a report may be compiled automatically upon completion of the survey, or at the request of the advertiser or other interested party.

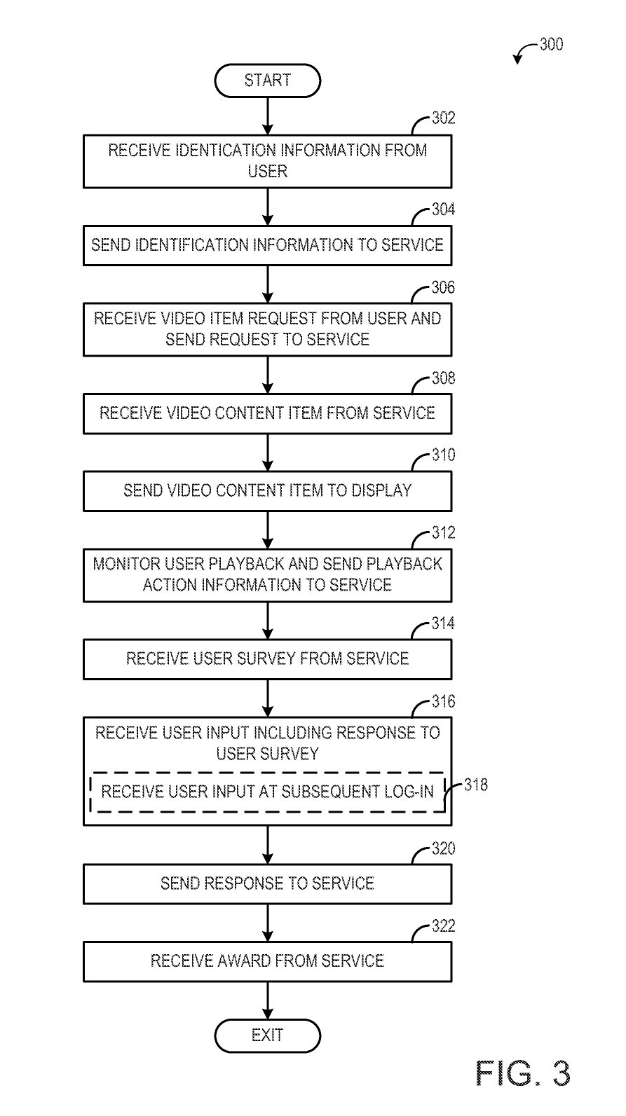

FIG. 3 shows a flow diagram illustrating an embodiment of a method 300 for presenting an advertising effectiveness survey to a user. Method 300 may be executed by a video presentation device such as computing system 102, and/or by any other suitable device. Method 300 includes, at 302, receiving a user input of user identification information. The identification information may be received during user login, or at any other suitable time and/or event.

At 304, method 300 includes sending the identification information to a remote service, such as a video delivery and survey service, to establish an identity of the user with the service. At 306, method 300 includes receiving a request for a video content item from a user, and sending a request to the service. Next, at 308, method 300 comprises receiving the video content item from the service, and at 310, providing the video content item to a display device for presentation to a user. The video content item may be provided to the display device as it is being received, or may be recorded and then provided to the display at a later time.

At 312, method 300 comprises monitoring user playback actions, and sending such user playback information to the service. As mentioned above, the user playback actions may include actions such as trick mode commands entered by the user during playback of the video content item (e.g. forward and reverse skip, fast forward and fast reverse, etc.). For example, the user's computing device may be configured to send a list of playback actions and corresponding timestamps to the service, and the service may be configured to determine from the playback actions which segments of the video content item were watched by the user, as described above. In other embodiments, the computing device may be configured to send any other suitable information regarding segments of the video content item that were presented to and likely viewed by the user.

At 314, method 300 includes receiving a user survey from the service. The survey may be assembled based on elements identified in the viewed video content item, as explained previously. At 316, method 300 comprises receiving user input that includes one or more responses to the survey. The response to the survey may be received during the same viewing session that the survey was received, or the response may be received upon a user initiating a subsequent login, as indicated at 318. At 320, the response to the survey is sent to the service, and in response, at 322, an award is received from the service for completing the user survey, as described above.

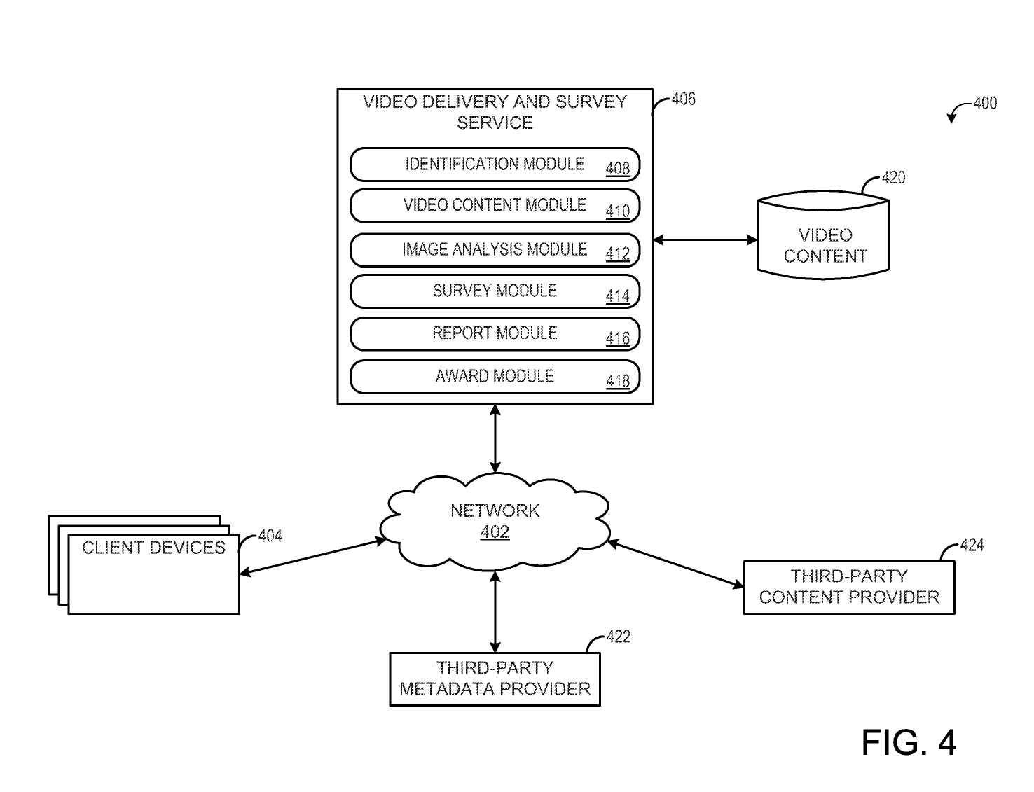

FIG. 4 shows an example embodiment of a video presentation and advertising survey system 400 (“survey system”) suitable for the implementation of the above-described embodiments. In FIG. 4, various parts of the survey system 400 are depicted as being physically separate from one another and connected via a network 402, while other devices and modules are depicted as being integrated. It will be understood that the particular configuration of devices, services and modules shown in FIG. 4 is presented for the purpose of example, and is not intended to be limiting in any manner.

The survey system 400 includes one or more client devices 404 configured to perform various tasks. For example, the client devices 404 may provide identification information to a service such as video delivery and survey service 406, send requests for video content, receive video content from one or more sources, monitor and send information regarding user playback actions that occur during video content presentation, receive user surveys related to the received video content, receive user inputs in response to the surveys, and/or other tasks described above. The client devices 404 may receive video content from any suitable source, including but not limited to video delivery and survey service 406, which may access video content stored remotely in a video content database 420. The client devices 404 may also receive video content from third party content providers, such as third party provider 424. Computing system 102 of FIG. 1 is a non-limiting example of a client device 404.

The video delivery and survey service 406 may include a plurality of modules configured to execute the various processes presented above with respect to FIG. 2. It will be understood that such modules may be physically and logically arranged in any suitable manner, and may be located remotely from one another in some embodiments. As one example, the video delivery and survey service may include an identification module 408 configured to receive identification information (e.g. login information) from the client devices 404 and associate each user with an identification, established account, etc., in order to facilitate sending the requested video content and subsequent user surveys and awards to the user. The identification module 408 also may be configured to assign anonymous identifications to users.

The video delivery and survey service 406 further may include a video content provision module 410 configured to provide video content to requesting devices. The video content may be retrieved from a video content database 420 local to the video delivery and survey service, or remotely from the video delivery and survey service 406. It will be understood that the video content database 420 also may include advertising content included in the video content items and/or for insertion into video content items.

The video delivery and survey service 406 also may include an image analysis module 412. The image analysis module 412 may identify image elements in video content, for example, by performing video content element identification analysis on each video content item delivered to a user. The video content element identification analysis may identify elements within a video content item, including people, places, products, brands, logos, and additional identifiable elements. The image analysis module 412 may perform the video content element identification analysis during playback of the video content item on a client device, prior to the video content item being sent to a client device, or after consumption of the video content item. Further, in some embodiments, such video content element identification analysis may be prior to receipt of the user's request for a video content item, and metadata relating to the results of the analysis (e.g. products/brands/etc. identifications, time stamp information, and/or other information) may be stored for later retrieval. Further, information relating to the identification of elements within the video content item may be obtained from a third-party metadata provider 422 that performs such analyses on video content items.

Video delivery and survey service 406 may further include a survey module 414 configured to automatically retrieve user surveys regarding identified element or elements in video content items. The survey module 414 may be further configured to receive information regarding playback actions the user took during playback of the video content item, in order to identify which segments of the video content item were actually presented to and likely viewed by the user. The user survey may then be configured to include questions relating to identified elements within viewed segments of the video content item. The survey module 414 may itself select one or more survey questions relating to the viewed identified element to include in the user survey, or may retrieve a pre-assembled user survey that includes questions relating to the viewed identified element. The survey module 414 sends the user survey to a client device associated with the user. The survey module 414 is also configured to send an identical user survey to a control user who has not viewed the identified element.

Continuing with FIG. 4, the video delivery and survey service 406 may include a report module 416 configured to receive responses to the user survey from users that have been sent the survey, including control users. The report module 416 may generate a report compiling results from the user survey that may be presented to an advertiser or other interested party. Further, the report module 416 may present the user survey report to the advertiser in an ongoing manner, so that the advertiser may see the results of the user survey during the entirety of the effectiveness research campaign, rather than waiting until all responses to the user survey have been received. The video delivery and survey service 406 may additionally include an award module 418 configured to send an award to the user after the user completes the user survey.

In some embodiments, the above described methods and processes may be tied to a computing system including one or more computers. In particular, the methods and processes described herein may be implemented as a computer application, computer service, computer API, computer library, and/or other computer program product.

FIG. 5 schematically shows a non-limiting computing system 500 that may perform one or more of the above described methods and processes. Computing system 500 is shown in simplified form. It is to be understood that virtually any computer architecture may be used without departing from the scope of this disclosure. In different embodiments, computing system 500 may take the form of a mainframe computer, server computer, desktop computer, laptop computer, tablet computer, home entertainment computer, network computing device, mobile computing device, mobile communication device, gaming device, wearable computer, etc.

Computing system 500 includes a logic subsystem 502 and a data-holding subsystem 504. Computing system 500 may optionally include a display subsystem 506, communication subsystem 508, and/or other components not shown in FIG. 5. Computing system 500 may also optionally include user input devices such as keyboards, mice, game controllers, cameras, microphones, and/or touch screens, for example.

Logic subsystem 502 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multi-core, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 504 may include one or more physical, non-transitory, devices configured to hold data and/or instructions executable by the logic subsystem to implement the herein described methods and processes. When such methods and processes are implemented, the state of data-holding subsystem 504 may be transformed (e.g., to hold different data).

Data-holding subsystem 504 may include removable media and/or built-in devices. Data-holding subsystem 504 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 504 may include devices with one or more of the following characteristics: volatile, nonvolatile, dynamic, static, read/write, read-only, random access, sequential access, location addressable, file addressable, and content addressable. In some embodiments, logic subsystem 502 and data-holding subsystem 504 may be integrated into one or more common devices, such as an application specific integrated circuit or a system on a chip.

FIG. 5 also shows an aspect of the data-holding subsystem in the form of removable computer-readable storage media 510, which may be used to store and/or transfer data and/or instructions executable to implement the herein described methods and processes. Removable computer-readable storage media 510 may take the form of CDs, DVDs, HD-DVDs, Blu-Ray Discs, EEPROMs, and/or floppy disks, among others.

It is to be appreciated that data-holding subsystem 504 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module” and “program” may be used to describe an aspect of computing system 500 that is implemented to perform one or more particular functions. In some cases, such a module and/or program may be instantiated via logic subsystem 502 executing instructions held by data-holding subsystem 504. It is to be understood that different modules and/or programs may be instantiated from the same application, service, code block, object, library, routine, API, function, etc. Likewise, the same module, program, and/or engine may be instantiated by different applications, services, code blocks, objects, routines, APIs, functions, etc. The terms “module” and “program” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 506 may be used to present a visual representation of data held by data-holding subsystem 504. As the herein described methods and processes change the data held by the data-holding subsystem, and thus transform the state of the data-holding subsystem, the state of display subsystem 506 may likewise be transformed to visually represent changes in the underlying data. Display subsystem 506 may include one or more display devices utilizing virtually any type of technology. Such display devices may be combined with logic subsystem 502 and/or data-holding subsystem 504 in a shared enclosure, or such display devices may be peripheral display devices.

When included, communication subsystem 508 may be configured to communicatively couple computing system 500 with one or more other computing devices. Communication subsystem 508 may include wired and/or wireless communication devices compatible with one or more different communication protocols. As non-limiting examples, the communication subsystem may be configured for communication via a wireless telephone network, a wireless local area network, a wired local area network, a wireless wide area network, a wired wide area network, etc. In some embodiments, the communication subsystem may allow computing system 500 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. In a computing device comprising a data-holding subsystem and logic subsystem, a method comprising:
receiving a request from a video presentation device for a video content item, the request associated with an identified user;
providing the video content item to the video presentation device;
receiving information relating to an image analysis of the video content item to identify one or more image elements in the video content item;
receiving and storing information regarding user playback actions during playback of the video content item;
automatically retrieving a user survey based upon the information related to the image analysis and the user playback actions;
sending the user survey to a device associated with the identified user; and
receiving a response to the user survey.

2. The method of claim 1, further comprising determining an identity of the identified user based on a received log-in request.

3. The method of claim 1, wherein the image analysis is performed prior to providing the video content item to the video presentation device.

4. The method of claim 1, wherein the image analysis is performed in real-time during playback of the video content item.

5. The method of claim 1, wherein receiving the information regarding the user playback actions further comprises receiving information regarding trick mode commands entered by the identified user in order to determine which segments of the video content item were watched by the identified user.

6. The method of claim 1, further comprising granting an award to the identified user after receiving the response to the user survey.

7. The method of claim 1, wherein sending the user survey further comprises sending the user survey to the device associated with the identified user in response to the identified user initiating a subsequent viewing session.

8. The method of claim 1, further comprising sending the user survey to a device associated with a control user, wherein the control user is not provided with the video content item.

9. The method of claim 1, wherein the video presentation device and the device associated with the user comprise a single device.

10. A data-holding device holding instructions executable by a logic subsystem to:
receive a log-in request from a device associated with a user to log-in to a viewing session;
identify the user based on the log-in request;
receive a request from the device for a video content item;
provide the video content item to the device;
perform a real-time image analysis to identify one or more image elements in the video content item as the video content item is being viewed by the user;
receive and store information regarding user playback actions during playback of the video content item;
after providing the video content item to the user, automatically assemble a user survey based upon the image analysis and the user playback actions;
in response to a subsequent user log-in to another viewing session, send the user survey to the device;
receive a response to the user survey; and
upon receiving the response, grant an award to the user.

11. The data-holding device of claim 10, wherein the instructions are further executable to send the user survey to a device associated with a control user not provided with the video content item.

12. The data-holding device of claim 10, wherein the user playback actions comprise trick mode operation during playback of the video content item, and wherein information regarding the trick mode operation is used to determine which segments of the video content item were presented to the user.

13. The data-holding device of claim 12, wherein the user survey comprises questions regarding one or more image elements identified from the image analysis present in viewed segments of the video content item.

14. The data-holding device of claim 10, wherein the instructions are further executable to generate a report compiling responses from the user survey and additional user surveys received from a plurality of identified users.

15. The data-holding device of claim 10, wherein the award is a virtual award.

16. In a computing device comprising a data-holding subsystem and logic subsystem, a method, comprising:
receiving log-in information from a user;
sending the log-in information to a service in order to establish an identity of the user;
sending a request to the service for a video content item;
receiving the video content item from the service;
sending the video content item to a display;
sending to the service information regarding user playback actions during presentation of the video content item;
after presentation of the video content item, receiving from the service a user survey related to an image element displayed in a segment of the video content item presented to the user;
receiving user input including a response to the user survey; and
sending to the service the response to the user survey.

17. The method of claim 16, further comprising receiving an award for the user from the service upon sending the response.

18. The method of claim 17, wherein the award comprises a virtual award.

19. The method of claim 16, wherein the user playback actions comprise trick mode operation during playback of the video content item, and wherein information regarding the trick mode operation is used to determine which segments of the video content item were presented to the user.

20. The method of claim 16, further comprising, after presentation of the video content item, sending log-in information to the service to initiate a subsequent user log-in, and receiving the user survey in response to sending the log-in information.
